(19) United States
(12) Patent Application Publication
(10) Pub. No.: US 2015/0353021 A1
(43) Pub. Date: Dec. 10, 2015

(54) Modular Rack Assembly

(71) Applicant: Don Orme, Long Beach, CA (US)

(72) Inventor: Don Orme, Long Beach, CA (US)

(21) Appl. No.: 14/295,403

(22) Filed: Jun. 4, 2014

(51) Int. Cl. B60R 7/08

(52) U.S. Cl. CPC B60R 7/08

(57) ABSTRACT

A modular rack assembly includes a base that may be positioned within a bed of a vehicle. A pair of support rails each has a pair of legs removably coupled to the base. The pair of support rails extends upwardly from the base. A plurality of cross members is removably coupled to between the pair of support rails. An object is positionable on each of the plurality of cross members. The assembly supports the object.

### BACKGROUND OF THE DISCLOSURE

### Field of the Disclosure

The disclosure relates to rack devices and more particularly pertains to a new rack device for being removably positioned within a vehicle so the rack carries an object.

### SUMMARY OF THE DISCLOSURE

An embodiment of the disclosure meets the needs presented above by generally comprising a base that may be positioned within a bed of a vehicle. A pair of support rails each has a pair of legs removably coupled to the base. The pair of support rails extends upwardly from the base. A plurality of cross members is removably coupled to between the pair of support rails. An object is positionable on each of the plurality of cross members. The assembly supports the object.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a modular rack assembly according to an embodiment of the disclosure.

FIG. 2 is an exploded perspective view of an embodiment of the disclosure.

FIG. 3 is a left side view of an embodiment of the disclosure.

FIG. 4 is a bottom view of an embodiment of the disclosure.

FIG. 5 is a cross sectional view taken along line 5-5 of FIG. 3 of an embodiment of the disclosure.

FIG. 6 is an in-use view of an embodiment of the disclosure.

### DESCRIPTION OF THE PREFERRED EMBODIMENT

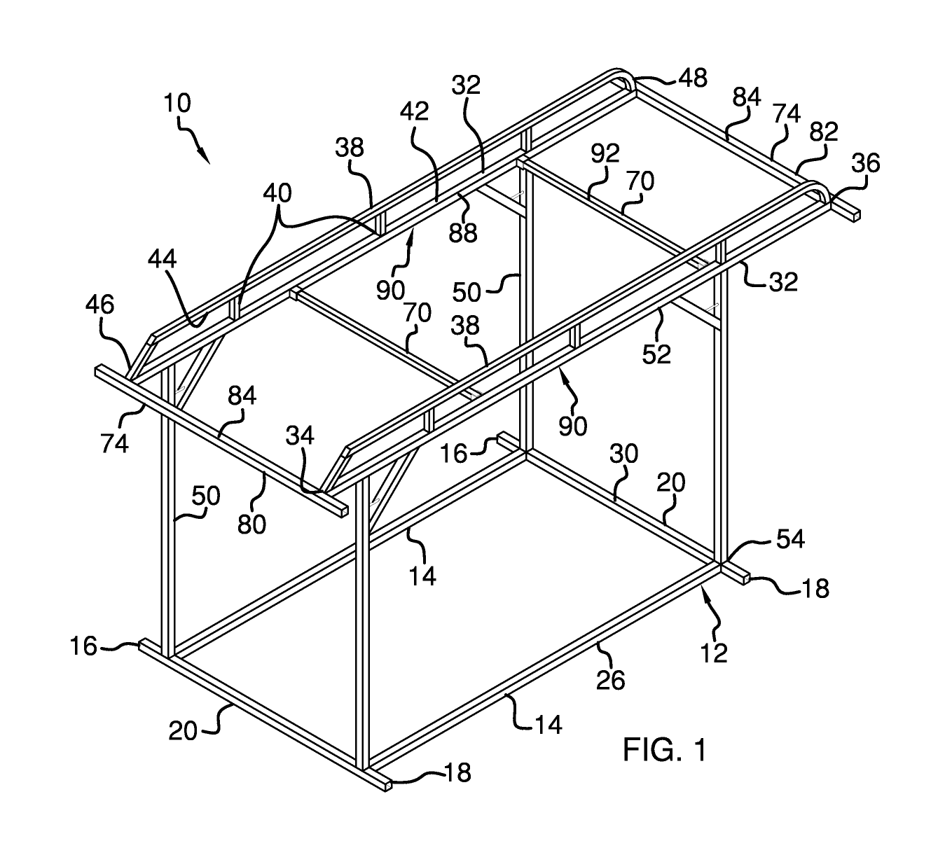

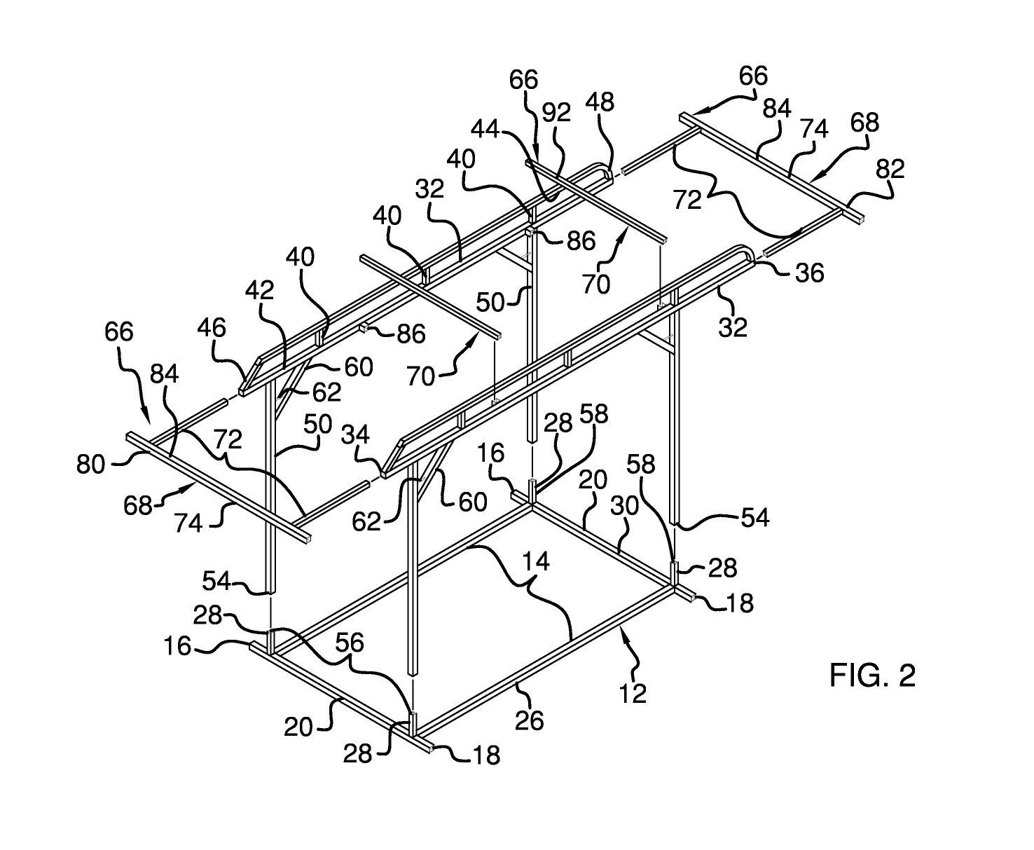

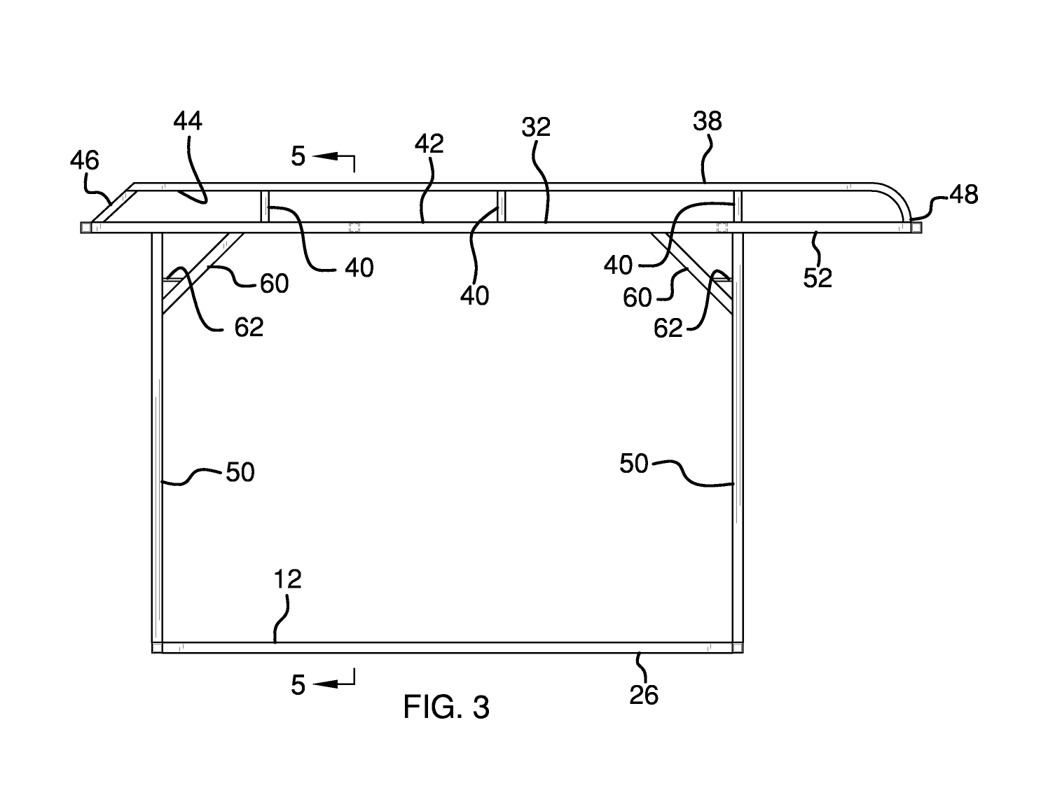

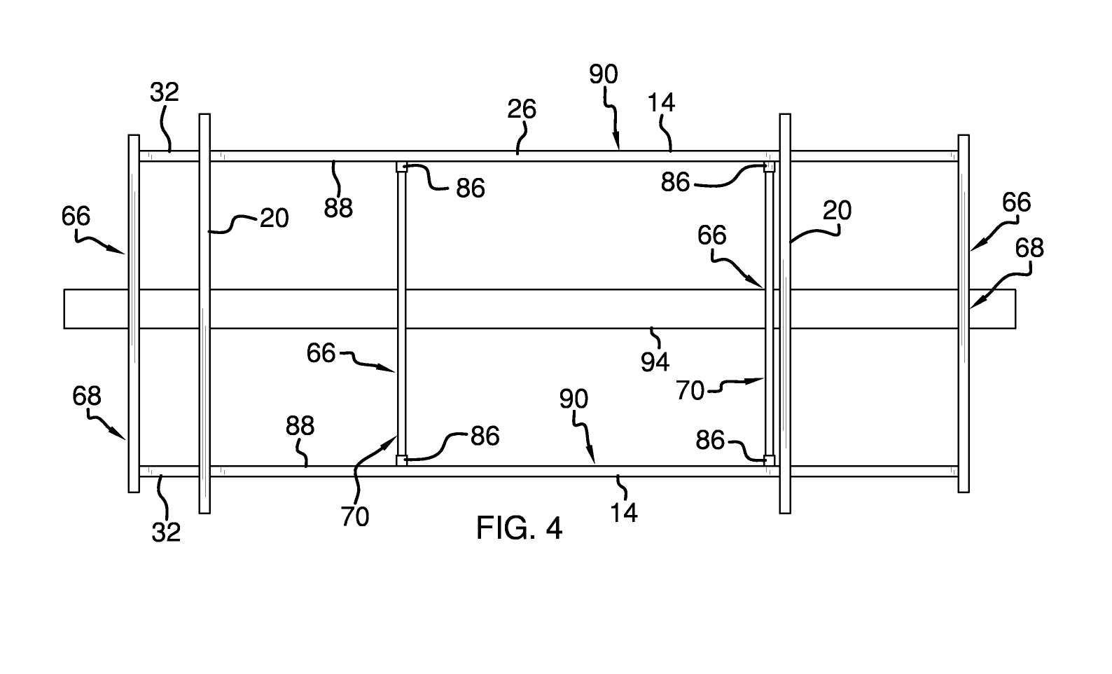

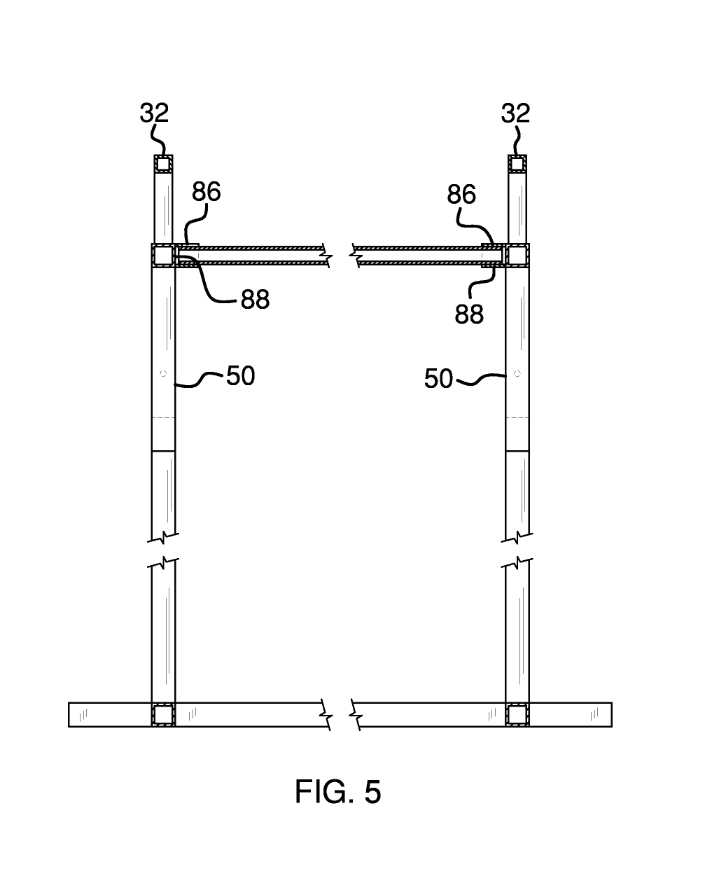

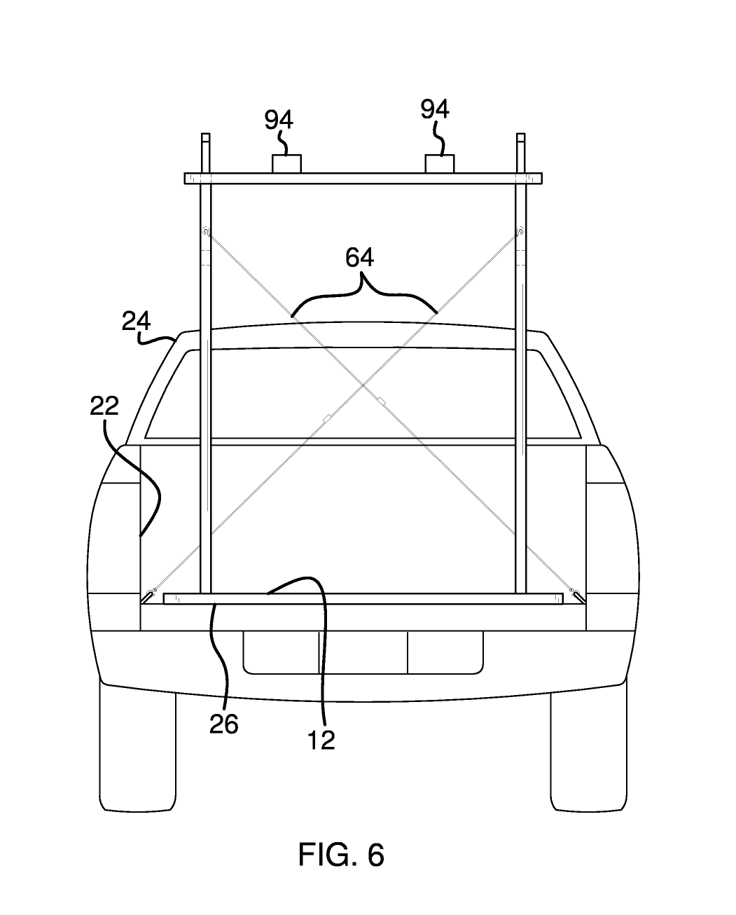

With reference now to the drawings, and in particular to FIGS. 1 through 6 thereof, a new rack device embodying the principles and concepts of an embodiment of the disclosure and generally designated by the reference numeral 10 will be described.

As best illustrated in FIGS. 1 through 6, the modular rack assembly 10 generally comprises a base 12. A pair of longitudinal arms 14 of the base 12 is each coupled between an associated one of a first end 16 and a second end 18 of a pair of lateral arms 20 of the base 12. The pair of longitudinal arms 14 of the base 12 are spaced inwardly from the associated one of the first 16 and second 18 ends of the pair of lateral arms 20 of the base 12. The base 12 may be positioned within a bed 22 of a vehicle 24 so a bottommost side 26 of the base 12 abuts the bed 22 of the vehicle 24. The vehicle 24 may be a pickup of any conventional design.

The base 12 has a plurality of mounting arms 28 each extending upwardly from a top side 30 of an associated one of each of the pair of lateral arms 20 of the base 12. Each of the plurality of mounting arms 28 is positioned proximate an intersection of the pair of longitudinal arms 14 and the pair of lateral arms 20 of the base 12. A pair of support rails 32 is provided. Each of the pair of support rails 32 has a front end 34 and a rear end 36. The front 24 and rear 36 ends of each of the pair of support rails 32 is open. Each of the pair of support rails 32 is elongated.

The pair of support rails 32 each has an upper member 38 extending between the front 34 and rear 36 ends of the pair of support rails 32. A plurality of supports 40 is coupled between an upper side 42 of an associated one of the pair of support rails 32 and a lower side 44 of an associated one of the pair of upper members 38. The plurality of supports 40 spaces an associated one of the pair of upper members 38 upwardly from the associated one of the pair of support rails 32. A frontmost end 46 of each of the pair of upper members 38 angles downwardly toward the associated one of the pair of support rails 32. A rearmost end 48 of each of the pair of upper members 38 curves downwardly toward the associated one of the pair of support rails 32.

Each of the pair of support rails 32 has a pair of legs 50 extending downwardly from a bottommost side 52 of an associated one of each of the pair of support rails 32. A bottom end 54 of each of the pair of legs 50 on each of the pair of support rails 32 is open. The pair of legs 50 on each of the pair of support rails 32 is positioned proximate an associated one of the front 34 and rear 36 ends of an associated one of each of the pair of support rails 32. The bottom end 54 of each of the pair of legs 50 on each of the pair of support rails 32 insertably receives an associated one of a first set 56 and a second set 58 of the plurality of mounting arms 28. Each of the pair of support rails 32 are spaced upwardly from the base 12. The pair of legs 50 are each spaced inwardly from an associated one of the front 34 and rear 36 ends of each of the pair of support rails 32.

A plurality of gussets 60 is coupled to each of the pair of support rails 32. The plurality of gussets 60 extends between the bottommost side 52 of each of the pair of support rails 32 and an associated one of the pair of legs 50 on each of the pair of support rails 32. A plurality of strap pegs 62 extends between each of the plurality of gussets 60 and an associated one of the pair of legs 50 on each of the pair of support rails 32.

A plurality of straps 64 is coupled between an associated one of the plurality of strap pegs 62 and the bed 22 on the vehicle 24. The plurality of straps 64 retains the assembly 10 within the bed 22 of the vehicle 24. Additionally, the plurality of straps 64 may each be a ratcheting strap of any conventional design.

A plurality of cross members 66 is provided. The plurality of cross members 66 comprise a first set 68 and a second set 70 of the plurality of cross members 66. Each of the first set of cross members 68 includes a pair of coupling arms 72 extending away from a central arm 74 of each of the first set of cross members 68. Each of the pair of coupling arms 72 is positioned proximate an associated one of a primary end 76 and a secondary end 78 of the central arm 74 of each of the first set of cross members 68. The first set of cross members 68 each has a U-shape.

The front end 34 of each of the pair of support rails 32 insertably receives an associated one of the pair of coupling arms 72 of a front one 80 of the first set of cross members 68. The rear end 36 of each of the pair of support rails 32 insertably receives an associated one of the pair of coupling arms 72 of a rear one 82 of the first set of cross members 68. An uppermost side 84 of the central arm 74 of each of the first set of cross members 68 lies on a plane being planar with the upper side 42 of each of the pair of support rails 32.

A pair of receivers 86 is coupled to an inward side 88 of each of the pair of support rails 32. The pair of receivers 86 on each of the pair of support rails 32 is evenly spaced apart from a middle 90 of each of the pair of support rails 32. Each of the second set of cross members 70 is coupled between an associated one of the pair of receivers 86 on each of the pair of support rails 32. A topmost side 92 of each of the second set of cross members 70 lies on a plane being planar with the upper side 42 of each of the pair of support rails 32. An object 94 is positionable on each of the plurality of cross members 66 so the assembly 10 supports the object 94.

In use, the assembly 10 is positioned within the bed 22 on the vehicle 24. The object 94 is positioned so the object 94 lies on each of the plurality of cross members 66. The assembly 10 is utilized to carry an object 94 with a length being greater than a length of the bed 22 of the vehicle 24. Additionally, the assembly 10 elevates the object 94 to prevent to object 94 from presenting a collision hazard to other vehicles. The assembly 10 may be left within the vehicle 24 for any length of time.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A modular rack assembly configured to be removably positioned within a vehicle wherein said assembly carries an object, said assembly comprising:
a base configured to be positioned within a bed of the vehicle;
a pair of support rails each having a pair of legs removably coupled to said base such that said pair of support rails extends upwardly from said base; and
a plurality of cross members removably coupled to between said pair of support rails, the object being positionable on each of said plurality of cross members such that said assembly supports the object.

2. The assembly according to claim 1, further comprising said base having a pair of longitudinal arms of said base each coupled between an associated one of a first end and a second end of a pair of lateral arms of said base.

3. The assembly according to claim 1, further comprising said base having a plurality of mounting arms each extending upwardly from a top side of an associated one of each of a pair of lateral arms of said base.

4. The assembly according to claim 3, further comprising each of said plurality of mounting arms being positioned proximate an intersection of a pair of longitudinal arms and said pair of lateral arms of said base.

5. The assembly according to claim 1, further comprising said pair of support rails each having a front end and a rear end, said front and rear ends of each of said pair of support rails being open, said pair of support rails each being elongated.

6. The assembly according to claim 1, further comprising said pair of legs on each of said pair of support rails extending downwardly from a bottommost side of an associated one of each of said pair of support rails, a bottom end of each of said pair of legs on each of said pair of support rails being open.

7. The assembly according to claim 6, further comprising said pair of legs on each of said pair of support rails being positioned proximate an associated one of a front end and a rear end of an associated one of each of said pair of support rails.

8. The assembly according to claim 1, further comprising a bottom end on each of said pair of legs on each of said pair of support rails insertably receiving an associated one of a first set and a second set of a plurality of mounting arms.

9. The assembly according to claim 1, further comprising said plurality of cross members comprising a first set and a second set of said plurality of cross members.

10. The assembly according to claim 1, further comprising each of a first set of said plurality of cross members including a pair of coupling arms extending away from a central arm of each of said first set of said plurality of cross members, each of said pair of coupling arms being positioned proximate an associated one of a primary end and a secondary end of said central arm of each of said first set of said plurality of cross members.

11. The assembly according to claim 1, further comprising a front end of each of said pair of support rails insertably receiving an associated one of a pair of coupling arms of a front one of a first set of said plurality of cross members.

12. The assembly according to claim 1, further comprising a rear end of each of said pair of support rails insertably receiving an associated one of a pair of coupling arms of a rear one of a first set of said plurality of cross members.

13. The assembly according to claim 1, further comprising each of a second set of said plurality of cross members being coupled between said pair of support rails such that each of said second set of said plurality of cross members are evenly spaced apart from a middle of said pair of support rails.

14. A modular rack assembly configured to be removably positioned within a vehicle wherein said assembly carries an object, said assembly comprising:
a base having a pair of longitudinal arms of said base each coupled between an associated one of a first end and a second end of a pair of lateral arms of said base, said base being configured to be positioned within a bed of the vehicle;
said base having a plurality of mounting arms each extending upwardly from a top side of an associated one of each of said pair of lateral arms of said base, each of said plurality of mounting arms being positioned proximate an intersection of said pair of longitudinal arms and said pair of lateral arms of said base;
a pair of support rails each having a front end and a rear end, said front and rear ends of each of said pair of support rails being open, said pair of support rails each being elongated;
each of said pair of support rails having a pair of legs extending downwardly from a bottommost side of an associated one of each of said pair of support rails, a bottom end of each of said pair of legs on each of said pair of support rails being open, said pair of legs on each of said pair of support rails being positioned proximate an associated one of said front and rear ends of an associated one of each of said pair of support rails;
said bottom end on each of said pair of legs on each of said pair of support rails insertably receiving an associated one of a first set and a second set of said plurality of mounting arms;
a plurality of cross members comprising a first set and a second set of said plurality of cross members;
each of said first set of cross members including a pair of coupling arms extending away from a central arm of each of said first set of cross members, each of said pair of coupling arms being positioned proximate an associated one of a primary end and a secondary end of said central arm of each of said first set of cross members;
said front end of each of said pair of support rails insertably receiving an associated one of said pair of coupling arms of a front one of said first set of cross members, said rear end of each of said pair of support rails insertably receiving an associated one of said pair of coupling arms of a rear one of said first set of cross members;
each of a second set of said plurality of cross members being coupled between said pair of support rails such that each of said second set of cross members are evenly spaced apart from a middle of said pair of support rails; and
the object being positionable on each of said plurality of cross members such that said assembly supports the object.
